(19) United States
(12) Patent Application Publication
(10) Pub. No.: US 2026/0351103 A1
(43) Pub. Date: Nov. 5, 2026

(54) AUDIO BLACKOUT DETECTION

(71) Applicant: TYCO FIRE & SECURITY GMBH, Neuhausen am Rheinfall (CH)

(72) Inventors: William WRIGHT, Belfast (GB); Paul FEE, Belfast (GB)

(21) Appl. No.: 19/195,461

(22) Filed: Apr. 30, 2025

(51) Int. Cl. G08B 13/196; G10L 25/78

(52) U.S. Cl. CPC G08B 13/19697; G08B 13/19634; G10L 25/78

(57) ABSTRACT

Example implementations include a method, apparatus and computer-readable medium of audio blackout detection in a security system, comprising recording an audio stream associated with a camera in the security system. The implementations further include determining if one or more audio detection test tones are present in the audio stream, wherein at least one of the one or more audio detection test tones is inaudible to a human. Additionally, the implementations further include generating one or more notifications if the one or more audio detection test tones are not present in the audio stream.

### FIELD

The present disclosure relates generally to security systems, and more particularly, to detecting audio interference with security systems.

### BACKGROUND

Video surveillance areas with limited and/or restricted access often include the use of one or more surveillance cameras, commonly referred to as closed circuit television (CCTV) cameras. Bad actors sometimes interfere with the video recording capabilities of CCTV cameras in an attempt to conceal their identities and/or actions. Various means are employed for such interference, including covering a lens of the camera with an object (e.g., a blanket, piece of clothing, or spray paint) and/or causing electronic interference with the CCTV camera.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example aspect includes a method of audio blackout detection in a security system, comprising recording an audio stream associated with a camera in the security system. The method further includes determining if one or more audio detection test tones are present in the audio stream, wherein at least one of the one or more audio detection test tones is inaudible to a human.

Another example aspect includes an apparatus for audio blackout detection in a security system, comprising one or more memories and one or more processors coupled with one or more memories and configured to perform, individually or in any combination, the following actions. The one or more processors are configured to record an audio stream associated with a camera in the security system. The one or more processors are further configured to determine if one or more audio detection test tones are present in the audio stream, wherein at least one of the one or more audio detection test tones is inaudible to a human. Additionally, the one or more processors are further configured to generate one or more notifications if the one or more audio detection test tones are not present in the audio stream.

Another example aspect includes an apparatus for audio blackout detection in a security system, comprising means for recording an audio stream associated with a camera in the security system. The apparatus further includes means for determining if one or more audio detection test tones are present in the audio stream, wherein at least one of the one or more audio detection test tones is inaudible to a human. Additionally, the apparatus further includes means for generating one or more notifications if the one or more audio detection test tones are not present in the audio stream.

Another example aspect includes a computer-readable medium having instructions stored thereon of audio blackout detection in a security system, wherein the instructions are executable by one or more processors, individually or in any combination, to perform the following actions. The instructions are executable to record an audio stream associated with a camera in the security system. The instructions are further executable to determine if one or more audio detection test tones are present in the audio stream, wherein at least one of the one or more audio detection test tones is inaudible to a human. Additionally, the instructions are further executable to generate one or more notifications if the one or more audio detection test tones are not present in the audio stream.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram showing an audio blackout detection system with a camera including a speaker and a microphone, according to some aspects;

FIG. 2 is a diagram showing an audio blackout detection system with a camera including a microphone and a separate speaker, according to some aspects;

FIG. 3 is a diagram showing an audio blackout detection system with a camera including a microphone and a neighbor camera including a speaker, according to some aspects;

FIG. 4 is a diagram showing an audio blackout detection system with a first user device including a camera, a speaker, and a microphone, according to some aspects;

FIG. 5 is a diagram showing an audio blackout detection system with a first user device including a camera and a microphone and a separate speaker, according to some aspects;

FIG. 6 is a block diagram of an example of a computer device having components configured to perform a method of audio blackout detection in a security system;

FIG. 7 is a flowchart of an example of a method of audio blackout detection in a security system;

FIG. 8 is a first flowchart of additional aspects of the method of FIG. 7;

FIG. 9 is a second flowchart of additional aspects of the method of FIG. 7;

FIG. 10 is a third flowchart of additional aspects of the method of FIG. 7;

FIG. 11 is a fourth flowchart of additional aspects of the method of FIG. 7;

FIG. 12 is a fifth flowchart of additional aspects of the method of FIG. 7; and

FIG. 13 is a sixth flowchart of additional aspects of the method of FIG. 7.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components may be shown in block diagram form in order to avoid obscuring such concepts.

Turning now to the figures, example aspects are depicted with reference to one or more components described herein, where components in dashed lines may be optional.

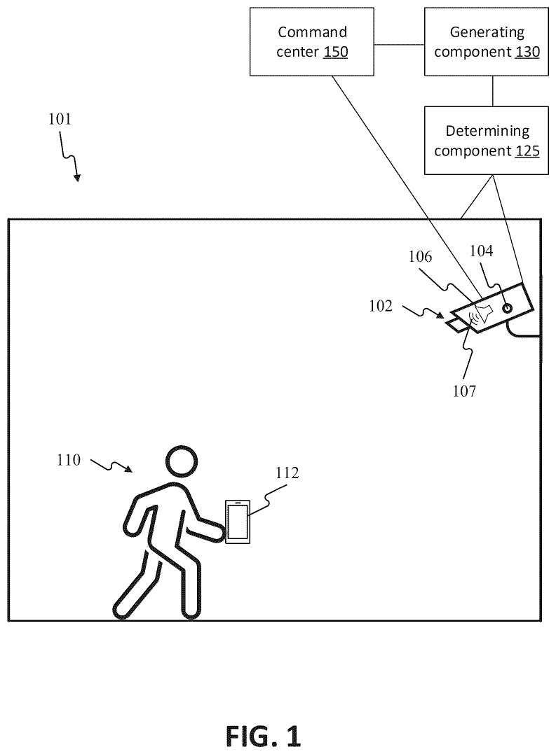

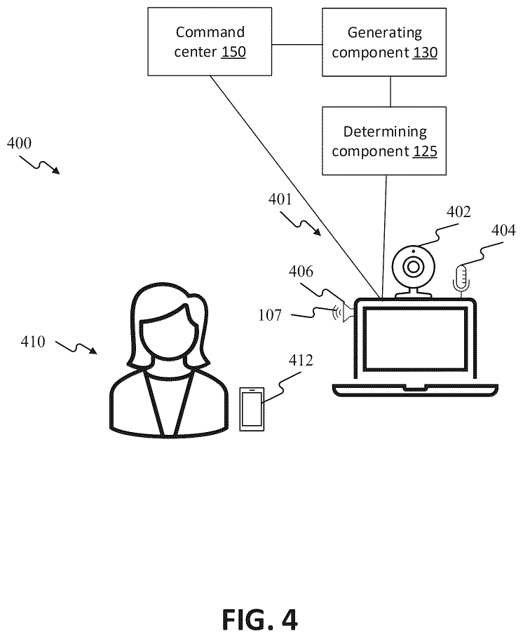

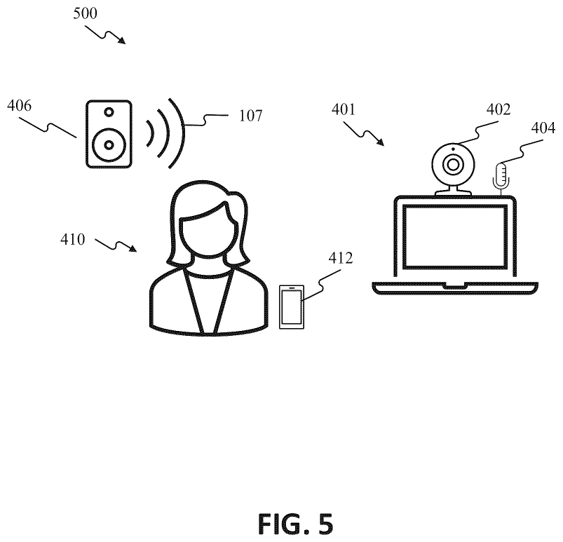

FIGS. 1-3 show various aspects of an audio blackout detection system in a surveillance context. In various aspects, the audio blackout detection systems shown in FIGS. 1-3 can share one or more characteristics of the audio blackout detection systems shown and described with respect to FIGS. 4-5.

FIG. 1 is a diagram showing an audio blackout detection system 101 with a camera 102 comprising a speaker 106 and a microphone 104, according to some aspects. As shown, a camera 102 can be a surveillance camera, such as a closed circuit television (CCTV) camera. Surveillance cameras can be removably mounted in a fixed location to monitor activity of or within a particular area, such as a secure and/or restricted access area, or another area where surveillance is desired.

In the aspect shown, camera 102 includes one or more microphones 104, which can be a transducer that is configured to receive sound waves that vibrate a diaphragm of the microphone and the resulting mechanical energy of the sound waves moving the diaphragm can be converted read as electrical energy variation signal(s) that can be recorded and/or transmitted.

Examples of sound waves that may be received by microphone 104 include ambient noise; vehicular noise, such as planes, helicopters, drones, missiles, or rockets taking off, motors and/or tires of cars, motorcycles, trucks, bicycles, skateboards, or other vehicles driving or parking, sounds from trains traveling on tracks, or other vehicular noise; natural sounds such as birds chirping, animals growling, barking, or howling, wind blowing, or other naturally occurring sounds; sounds generated by humans such as human speech, footsteps, and sounds generated by other human activity such as a person using tools, typing on a keyboard, playing sports, playing musical instruments, or other human generated sounds; and/or artificial sounds generated by human created machines and/or devices, such as sounds generated by operation of a power plant, large machinery such as a crane, speakers outputting audible and/or inaudible sounds, and/or other artificial sounds.

While many sounds received by a microphone are audible, i.e., they can be heard by humans (e.g., between about 20 Hz and about 20,000 Hz or even between about 12 Hz and about 28,000 Hz), microphones can also receive and record and/or transmit inaudible sounds, i.e. sounds which cannot be heard by humans. Inaudible sounds are caused by vibrations that travel through the air and/or other medium (e.g., gas, liquid, or solid), but which are unable to be heard by humans. Examples of inaudible sounds include high-frequency sounds with vibrations above the spectrum of human audible noise (e.g., above 20,000 Hz or even above 28,000 Hz at a high end) and low-frequency sounds with vibrations below the spectrum of human audible noise (e.g., below 20 Hz or even below 12 Hz at a low end).

Camera 102 can also include one or more speaker 106 that is configured to generate and/or emit sounds, such as one or more audio detection test tones 107 (e.g., a sound with a particular pitch, quality, and/or strength). In various aspects, speaker 106 can be configured to generate and/or emit audio detection test tones 107, which can be audible and/or inaudible. Audio detection test tones 107 generated and/or emitted by speaker 106 and can be arranged, configured, and/or played simultaneously and/or in a particular sequence (e.g., a plurality of audio detection test tones 107 played simultaneously and/or in a particular order). A sequence of audio detection test tones 107 can be periodic and/or aperiodic/irregular in various aspects. For example, a sequence of audio detection test tones 107 can be generated and/or emitted at regular intervals (e.g., every five seconds, every thirty seconds, every ten minutes, or at other regular intervals). As another example, a sequence of audio detection test tones 107 can be generated at irregular intervals (e.g., with non-standardized spacing between generation/emission of such tones). As another example, a sequence of audio detection test tones 107 can include both regular and irregular intervals.

In some aspects, a person 110 who is within a particular proximity to camera 102 may be a bad actor who intends to circumvent surveillance by camera 102 in order to perform a nefarious act, such as attempting to access a restricted and/or prohibited area, commit a crime, or perform some other improper act in an area monitored by camera 102. Person 110 may be carrying and/or using a device 112 that is configured to jam, block, or otherwise interfere with audio and/or video surveillance in the area monitored by camera 102. In some aspects, a person 110 could use an object, such as a low-tech item (e.g., a cloth or other item or object) to cover microphone 104. In some aspects, person 110 can use an object, such as a high-tech device 112 that may be configured to emit one or more signals that compromises or otherwise thwarts the ability of camera 102 (and more specifically, a microphone 104 of a camera 102) to surveil the area it is intended and/or configured to monitor (e.g., by reducing or eliminating the effectiveness of the microphone 104 to record a quality audio recording of the surveilled area). In various aspects, device 112 can be a user device such as a smartphone, laptop computer, tablet, phablet, proprietary device, or other user device. In various aspects device 112 can be a special and/or customized device that is specifically configured to perform audio and/or video jamming operations. In some aspects, device 112 may not require the presence of person 110, and could be placed in proximity to camera 102. Additionally or alternatively, in some aspects device 112 can be autonomously transported within proximity of camera 102, for example by an autonomous vehicle, drone, animal (e.g., trained or untrained).

In operation, according to some aspects, an audio blackout detection system with a camera 102 can be configured such that speaker 106 emits one or more audio detection test tones 107 that are received by microphone 104. During surveillance operations, microphone 104 receives the one or more audio detection test tones 107, which can be processed by a determining component 125 that is communicatively coupled with microphone 104 and configured to detect the one or more audio detection test tones 107.

If the determining component 125 detects the presence of the one or more audio detection test tones 107 emitted by the speaker 106 and received by the microphone 104, then the system may continue normal surveillance operations. In some aspects, an indication that the one or more audio detection test tones 107 have been properly detected can be stored in memory in an operation log or register and associated with a timestamp. This can allow a user and/or computer program to review the operation log if an anomaly occurs, if maintenance and/or replacement is required, or otherwise, so that the user and/or computer program has a proper cataloguing of normal surveillance operations.

In some aspects, if the determining component 125 fails to detect the presence of one or more of the one or more tones emitted by the speaker 106 in an audio stream captured by the microphone 104, an indication of this failure can be generated by a generating component 130 and stored in memory and/or communicated. In various aspects generating component 130 can generate a notification, alert, and/or alarm, which can be transmitted to a device of a predetermined and/or preconfigured notification recipient. As an example, if the determining component 125 fails to detect one or more of the one or more audio detection test tones 107, a notification can be generated by generating component 130 and sent to a user device of a surveillance technician, security personnel, police, security company, or other authorized entity. As another example, if the determining component 125 fails to detect one or more of the one or more audio detection test tones 107, a notification can be generated and sent to a device with a computer program that is configured to determine if active interference in the audio stream captured by microphone 104 is or is likely to be occurring, for example by cross-referencing with a video stream captured by camera 102 or another camera, and/or by determining if ambient or other noise is likely to be interfering with the audio stream, or by determining if a hardware and/or software malfunction has occurred. In another aspect, if the determining component 125 fails to detect one or more of the one or more audio detection test tones 107, generating component 130 can generate a notification that is displayed during an associated video stream that indicates that audio interference is or may be occurring.

In some aspects, a command center 150 can be a security monitoring station and/or server that is communicatively coupled via wireless and/or wired connection with camera 102. Command center 150 can include one or more processors, memory, operating systems, and/or other components and/or can be configured to be commutatively coupled with one or more user interface displays to display a video feed captured by camera 102. In various aspects, command center 150 can also control and/or issue commands to camera 102, speaker 106, and/or microphone 104. Accordingly, command center 150 can issue one or more commands to speaker 106 to emit one or more audio detection test tones 107.

In various aspects, determining component 125 and/or generating component 130 can be integrated in command center 150, camera 102, and/or distributed between command center 150 and camera 102.

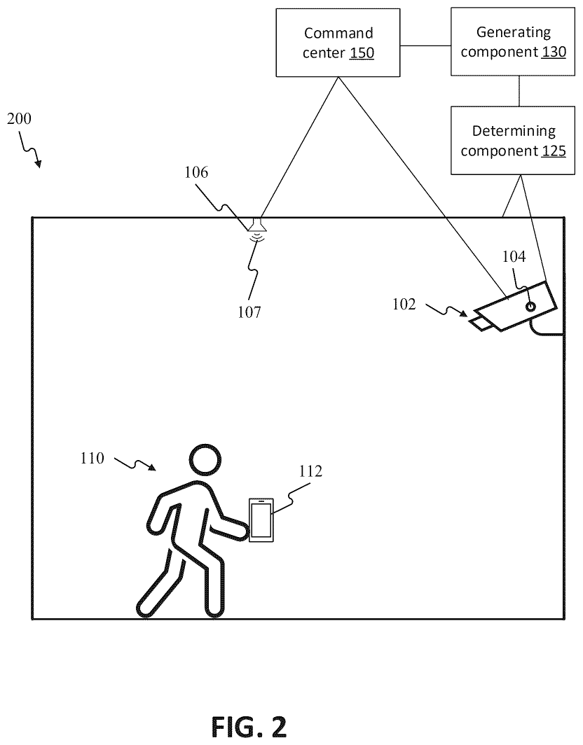

FIG. 2 is a diagram showing an audio blackout detection system 200 with a camera 102 including a microphone 104 and a separate speaker 106, according to some aspects. Operation of the audio blackout detection system shown in FIG. 2 can be similar to operation of the audio blackout detection system described with respect to FIG. 1. As shown in FIG. 2, speaker 106 may be separately located from camera 102, e.g., not co-located within camera 102. In various aspects speaker 106 can be a standalone speaker device that is removably installed in a fixed location and/or can be mobile. In some aspects, speaker 106 can be integrated with another device, such as a fire alarm, electronic panel, or other device that is located in proximity to camera 102. In some aspects, speaker 106 can be a component of another device such as a television or user device (e.g., smartphone, tablet, phablet, laptop computer, desktop computer, or other user device).

In aspects as shown in FIG. 2, one or more audio detection test tones 107 can be emitted by speaker 106 upon a signal, command, and/or trigger that is received via wired and/or wireless communication connection. For example, a signal, command, and/or trigger can be transmitted from camera 102 to speaker 106 via a wireless communication connection to emit the one or more audio detection test tones 107. It should be understood that in such examples, speaker 106 can be configured to receive and camera 102 can be configured to transmit such signal, command, and/or trigger via one or more wireless communications components. In some aspects, speaker 106 can send an acknowledgement and/or confirmation message and/or indicator that the signal, command, and/or trigger has been received. Additionally, or alternatively, speaker 106 can send an acknowledgement and/or confirmation message and/or indicator that the one or more audio detection test tones 107 have been emitted, which can be associated with a timestamp and/or timing indication. Accordingly, determining component 125 can determine if the one or more audio detection test tones 107 are or were received at a corresponding time in an audio stream by microphone 104.

In some aspects, command center 150 can also control and/or issue commands to camera 102, speaker 106, and/or microphone 104. Accordingly, command center 150 can issue one or more commands to speaker 106 to emit one or more audio detection test tones 107.

Also, in some optional aspects, the command center 150 may additionally include a user interface component operable to receive inputs from a user and further operable to generate outputs for presentation to the user (e.g., via a display interface to a display device). The user interface component may include one or more input devices, including but not limited to a keyboard, a number pad, a mouse, a touch-sensitive display, a navigation key, a function key, a microphone, a voice recognition component, or any other mechanism capable of receiving an input from a user, or any combination thereof. Further, the user interface component may include one or more output devices, including but not limited to a display interface, a speaker, a haptic feedback mechanism, a printer, any other mechanism capable of presenting an output to a user, or any combination thereof.

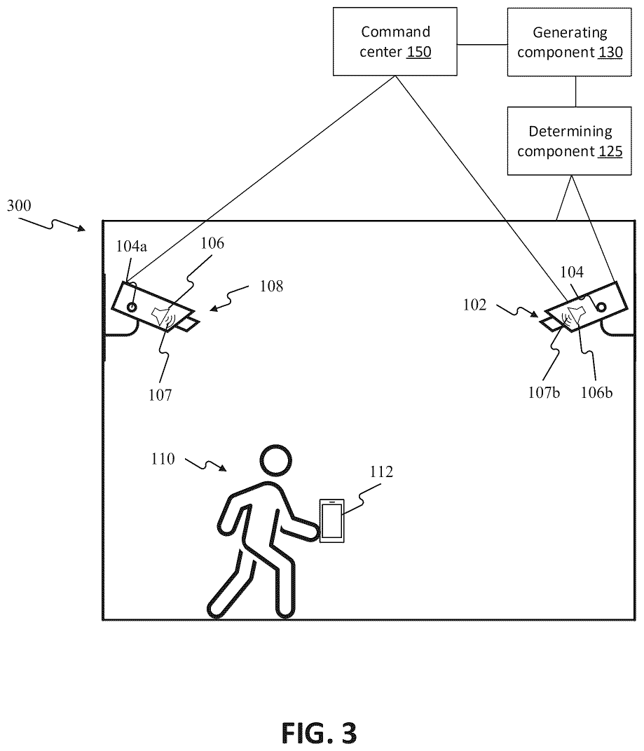

FIG. 3 is a diagram showing an audio blackout detection system 300 with a camera 102 including a microphone 104 and a neighbor camera 108 including a speaker 106, according to some aspects. Operation of the audio blackout detection system shown in FIG. 3 can be similar to operation of the audio blackout detection system described with respect to FIG. 1 and/or FIG. 2. As shown in FIG. 3, a camera 102 can include a microphone 104 that is configured to receive one or more tones 107 generated and/or emitted by a speaker 106 of a neighbor camera 108. Similarly, a neighbor camera 108 can include a microphone 104a that is configured to receive one or more tones 107b generated and/or emitted by a speaker 106b of a camera 102. In various aspects, the use of a microphone 104 of a camera 102 to receive audio signals such as one or more audio detection test tones 107 generated by a speaker 106 of a neighbor camera 108 can generate redundancy and/or overlapping audio detection of an area surveilled by camera 102, neighbor camera 108, and/or additional cameras (not shown). Accordingly, in an example aspect a network of cameras can be integrated in an audio blackout detection system whereby a person 110 using a device 112 to jam surveillance of one or more cameras is unable to jam surveillance of other cameras integrated in the network and a notification, alert, and/or alarm generated by one or more of the cameras (e.g., camera 102) will allow for discovery and swift apprehension of the person 110 and/or disabling of the device 112 performing the surveillance jamming operation.

In various aspects camera 102 and neighbor camera 108 can be communicatively coupled via wired and/or wireless connection. Accordingly, one or more audio detection test tones 107 can be emitted by speaker 106 upon receipt of a signal, command, and/or trigger by neighbor camera 108 via wired and/or wireless communication connection from camera 102. For example, a signal, command, and/or trigger can be transmitted from camera 102 to speaker 106 via a wireless communication connection to emit the one or more audio detection test tones 107. It should be understood that in such examples, neighbor camera 108 can be configured to receive and camera 102 can be configured to transmit such signal, command, and/or trigger via one or more wireless communications components. In some aspects, neighbor camera 108 can send an acknowledgement and/or confirmation message and/or indicator that the signal, command, and/or trigger has been received. In some aspects, this acknowledgement and/or confirmation message and/or indicator that the signal, command, and/or trigger has been received can be stored in memory. Additionally or alternatively, neighbor camera 108 can send an acknowledgement and/or confirmation message and/or indicator that the one or more audio detection test tones 107 have been emitted, which can be associated with a timestamp and/or timing indication. Accordingly, determining component 125 can determine if the one or more audio detection test tones 107 are or were received at a corresponding time in an audio stream by microphone 104.

In some aspects, a command center 150 can be a security monitoring station and/or server that is communicatively coupled via wireless and/or wired connection with one or more of camera 102 and neighbor camera 108. Command center 150 can include one or more processors, memory, operating systems, and/or other components and/or can be configured to be commutatively coupled with one or more user interface displays to display a video feed captured by camera 102 and/or neighbor camera 108. In various aspects, command center 150 can also control and/or issue commands to camera 102, neighbor camera 108, speaker 106, and/or microphone 104. Accordingly, command center 150 can issue one or more commands to speaker 106 to emit one or more audio detection test tones 107.

Turning now to FIGS. 4-5, various aspects of an audio blackout detection system in a webcam communications context will be provided. In various aspects, the audio blackout detection systems shown in FIGS. 4-5 can share one or more characteristics of the audio blackout detection systems shown and described with respect to FIGS. 1-3. In the context of FIGS. 4-5, an audio blackout detection system can determine if a user of a device including a webcam is interfering with recording of an audio stream via a microphone.

FIG. 4 is a diagram showing an audio blackout detection system 400 with a user device 401 including a camera 402, a speaker 406, and a microphone 404, according to some aspects. In some aspects, one or more of the camera 402, the speaker 406, and the microphone 404 can be integrated with user device 401, such as if user device 401 is a laptop computer, tablet, phablet, desktop computer, or smartphone. Alternatively, and/or additionally, one or more of the camera 402, the speaker 406, and the microphone 404 can be communicatively coupled with user device 401 via wired and/or wireless connection. Similar to the person 110 and device 112 of FIGS. 1-3, a person 410 can use a device 412 to interfere with audio reception and/or recording by microphone 404. Accordingly, an audio blackout detection system can cause speaker 406 to emit one or more audio detection test tones 107 for reception by microphone 404. Determining component 125, generating component 130, and command center 150 can operate in a similar manner to that described above with respect to FIGS. 1-3.

Command center 150 may differ from the aspects described with respect to FIGS. 1-3 in that it may not be configured for surveillance. Instead, command center can be a monitoring platform for use in online meetings and/or by an employer or other administrator to ensure that a person 410 (e.g., a remote attendee at an online conference, student attending class, employee participating in a meeting and/or performing work related tasks, lawyer attending a hearing, or other person subject to monitoring) is not interfering with a microphone and/or audio recording.

FIG. 5 is a diagram showing an audio blackout detection system 500 with a first user device 401 including a camera 402 and a microphone 404 and a separate speaker 406, according to some aspects. Various aspects of FIG. 5 can be similar to those described with respect to FIGS. 1-4. As shown in FIG. 5, in some aspects a speaker 406 can be located separately from a device 401 and/or microphone 404. This configuration can occur, for example, in a workplace where a person 410 is an employee working at a work station and a supervisor is not located nearby.

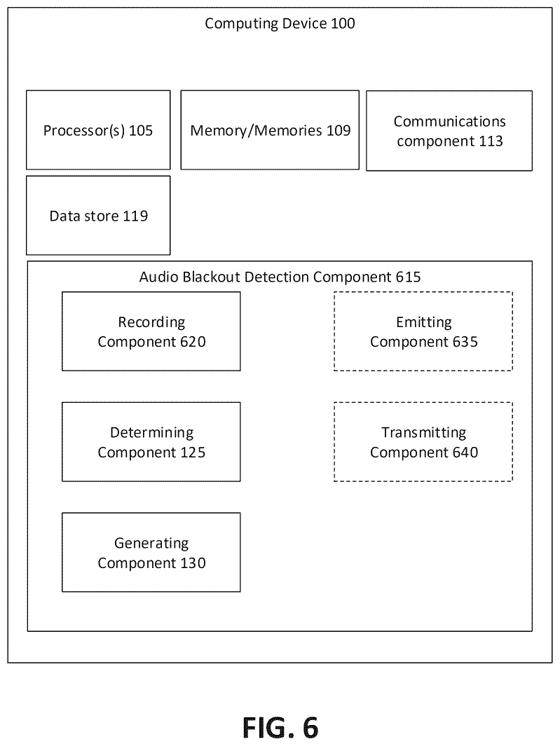

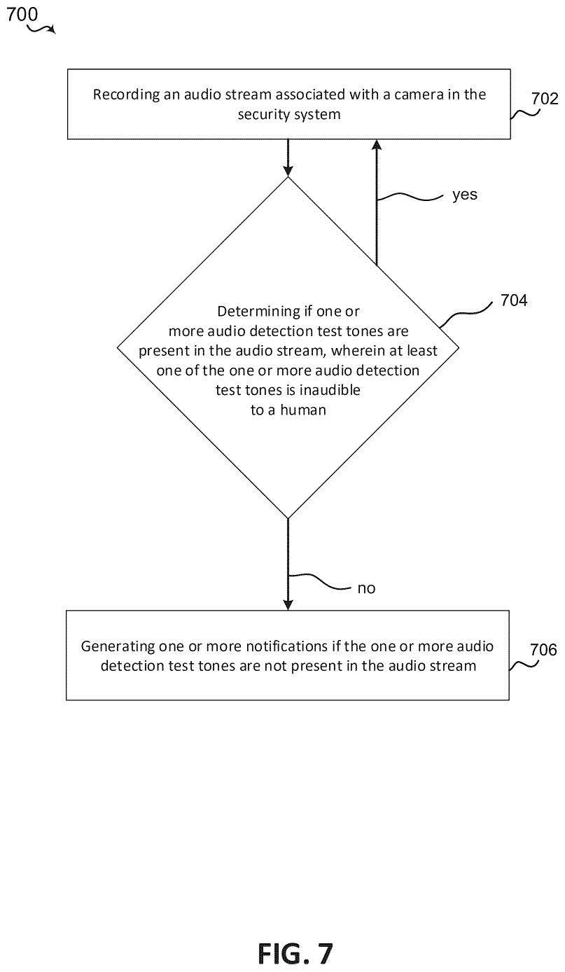

Referring to FIG. 6 a computing device 100 (e.g., a camera 102, camera 402, command center 150, and/or combinations thereof) may perform a method (e.g., method 700 of FIG. 7) of audio blackout detection in a security system, such as via execution of audio blackout detection component 615 by one or more processors 105 configured, individually or in any combination, to execute instructions to perform the following actions, and/or configured to communicate with one or more memories 109 to obtain the instructions.

The computing device 100 may include one or more processors 105 which may be configured to execute or implement software, hardware, and/or firmware modules that perform any functionality described above with reference to one or more components including a camera, device, speaker, and/or microphone.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

The one or more processors 105 may include a micro-controller and/or may include a single or multiple set of processors or multi-core processors. Moreover, the one or more processors 105 may be implemented as an integrated processing system and/or a distributed processing system. The computing device 100 may further include one or more memories 109, such as for storing local versions of applications being executed by the one or more processors 105, related instructions, parameters, etc. The one or more memories 109 may include a type of memory usable by a computer, such as random access memory (RAM), read only memory (ROM), tapes, flash drives, magnetic discs, optical discs, volatile memory, non-volatile memory, and any combination thereof. Additionally, the one or more processors 105 and the one or more memories 109 may include and execute an operating system executing on the one or more processors 105, one or more applications, display drivers, etc., and/or other components of the computing device 100.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, In combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

Further, the computing device 100 (e.g., a camera 102, 108, webcam 402, command center 150, and/or another device) may include a communications component 113 that provides for establishing and maintaining communications with one or more other devices, parties, entities, etc., utilizing hardware, software, and services. The communications component 113 may carry communications between components on the computing device 100, as well as between the computing device 100 and external devices, such as devices located across a communications network and/or devices serially or locally connected to the computing device 100. For example, the communications component 113 may include one or more buses, and may further include transmit chain components and receive chain components associated with a wireless or wired transmitter and receiver, respectively, operable for interfacing with external devices.

In some optional aspects, the computing device 100 may additionally include a data store 119, which can be any suitable combination of hardware and/or software, that provides for mass storage of information, databases, and programs. For example, the data store 119 may be or may include a data repository for applications and/or related parameters not currently being executed by the one or more processors 105. In addition, the data store 119 may be a data repository for an operating system, application, display driver, etc., executing on the one or more processors 105, and/or one or more other components of the computing device 100.

Referring to FIG. 7, in operation, computing device (e.g., computing device 100 of FIG. 6 (e.g., a camera 102, camera 402, command center 150, and/or combinations thereof)) may perform a method 700 of audio blackout detection in a security system, such as via execution of audio blackout detection component 615 by one or more processors 105 configured, individually or in any combination, to execute instructions to perform the following actions, and/or configured to communicate with one or more memories 109 to obtain the instructions.

At block 702, the method 700 includes recording an audio stream associated with a camera in the security system. For example, in an aspect, computing device 100, one or more processors 105, one or more memories 109, audio blackout detection component 615, and/or recording component 620 may be configured to or may comprise means for recording an audio stream associated with a camera in the security system.

For example, the recording at block 702 may include turning on or otherwise enabling a microphone (e.g., a microphone 104 or 404) to receive one or more audio signals that comprise an audio stream. For example, a user can select a button to turn on a microphone and/or a computer program stored in memory can automatically turn on a microphone before or during an associated audio stream. In some aspects, the audio stream can be associated with a video stream. The received audio signals and/or audio stream can be stored in memory and/or memories (e.g., memory/memories 109) and/or transmitted via a wired and/or wireless communications link.

Further, for example, the recording at block 702 may be performed in order to store an audio stream that can then be checked for one or more audio detection test tones. This may be performed in order to determine whether an audio stream and/or a recording component 620 such as a microphone is being interfered with, referred to herein as an audio blackout. Further, the recording at block 702 can be performed so that if an audio blackout is detected, corrective action can be taken and/or knowledge of the audio blackout can be reported to an appropriate entity (e.g., security personnel, manager(s), or other appropriate entities). Additionally, the recording at block 702 can be subsequently reviewed and/or checked for accuracy, in some aspects. For example, a secondary determination can be performed in order to determine if a result of an initial determination was accurate.

At block 704, the method 700 includes determining if one or more audio detection test tones are present in the audio stream, wherein at least one of the one or more audio detection test tones is inaudible to a human. For example, in an aspect, computing device 100, one or more processors 105, one or more memories 109, audio blackout detection component 615, and/or determining component 125 may be configured to or may comprise means for determining if one or more audio detection test tones are present in the audio stream, wherein at least one of the one or more audio detection test tones is inaudible to a human.

For example, the determining at block 704 may include determining if one or more audio detection test tones are present in the audio stream. In various aspects, determining if the one or more audio detection test tones are present in the audio stream can be accomplished by the determining component 125 receiving the audio stream (e.g., from the recording component 620 or retrieving the audio stream from memory) and checking the audio stream for the one or more audio detection test tones at times where they are expected to be present. For example, before the one or more audio detection test tones are emitted, a time can be associated with the one or more audio detection test tone emissions. Then, the associated time at which the one or more audio detection test tones were emitted can be checked in the audio stream.

Presence of the one or more audio detection test tones in the recorded audio stream at the associated time can indicate that the recording component 620 and/or the audio signals recorded thereby have not been tampered with. Absence or lack of clarity as to whether the one or more audio detection test tones are present at the associated time in the recorded audio stream can indicate that recording component 620 and/or the audio signals recorded thereby have been tampered with (e.g., by an audio jamming mechanism, covering the recording component, turning the recording component off, or otherwise). If the one or more audio detection test tones are present at the associated time in the audio stream, determining component 125 can provide no output (i.e., passively indicating that no audio blackout has occurred).

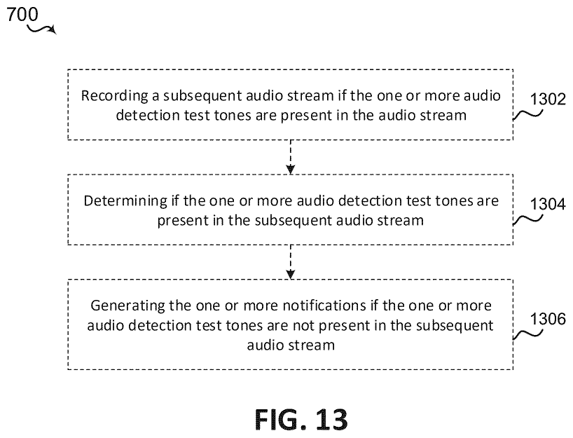

Alternatively, or additionally, the one or more audio detection test tones are present at the associated time in the audio stream, determining component 125 can provide an output such as a confirmation indicator (i.e., actively indicating that the one or more audio detection test tones are present in the audio stream at the associated, expected time). Accordingly, in some aspects, in the event that no audio blackout has occurred, determining component 125 may store a confirmation indicator in memory that indicates that the one or more audio detection test tones are present in the audio stream at the associated, expected time. Then, the method can optionally repeat block 702 (e.g., as shown in FIG. 13 and the associated description).

Alternatively, if the determining component 125 determines that one or more audio detection test tones are not present at the associated, expected time in the audio stream, the determining component 125 can cause the generating component 130 to generate a notification, alert, and/or alarm, thereby indicating an audio blackout and/or anomaly.

Further, for example, the determining at block 704 may be performed so that corrective action can be taken and/or knowledge of the audio blackout can be reported to an appropriate entity (e.g., security personnel, manager(s), or other appropriate entities). This determining can be performed in real-time or near real-time in some aspects (e.g., in security implementations) in order for a quick response to occur, such as a review, remedial action (e.g., a check and maintenance/fixing a defective recording component), or human or autonomous intervention (e.g., a person or autonomous vehicle can check an area near the recording component 620 and/or camera).

At block 706, the method 700 includes generating one or more notifications if the one or more audio detection test tones are not present in the audio stream. For example, in an aspect, computing device 100, one or more processors 105, one or more memories 109, audio blackout detection component 615, and/or generating component 130 may be configured to or may comprise means for generating one or more notifications if the one or more audio detection test tones are not present in the audio stream.

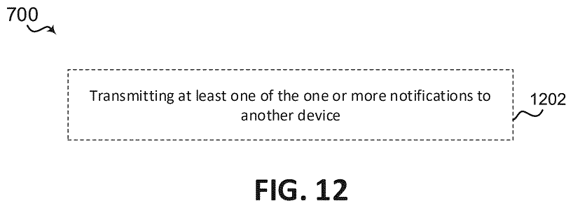

For example, the generating at block 706 may include generating one or more notifications if the one or more audio detection test tones are not present in the audio stream, including one or more of an audio alert, a visual alert, a haptic alert, and/or a data alert. Examples of an audio alert include a sound or other audible notification or alarm that is emitted via a speaker (e.g., at a control center, at the monitoring device, or on a user device). Examples of a visual alert include turning on and/or flashing a light (e.g., a light emitting diode (LED); a popup, banner, frame, or other notification on a display of a user device (e.g., a laptop or desktop computer, a television, a security monitor, a handheld device such as a smartphone, a proprietary device, or other user device); or another visual indicator. Examples of a haptic alert include a vibration of a user device. Examples of a data alert include an email, message (e.g., SMS or other message), or other data alert. In some aspects, the one or more generated notifications can be transmitted one or more other devices (e.g., as shown in FIG. 12 and described in the associated description).

Generating a notification can be performed in real-time or near real-time in some aspects (e.g., in security implementations) in order for a quick response to occur, such as a review, remedial action (e.g., a check and maintenance/fixing a defective recording component), or human or autonomous intervention (e.g., a person or autonomous vehicle can check an area near the recording component 620 and/or camera).

In an alternative or additional aspect, the one or more audio detection test tones comprise a plurality of tones. In some aspects, the plurality of tones may be unique to the camera (i.e., one camera may be associated with a first plurality of tones and a neighbor camera may be associated with a second plurality of tones).

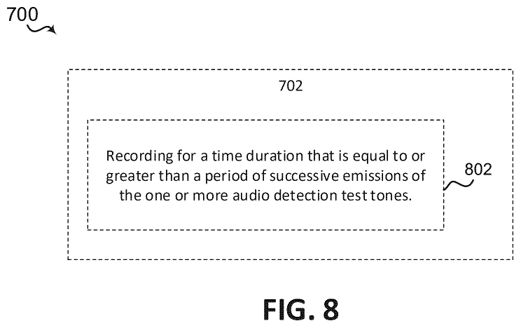

Referring to FIG. 8, in an alternative or additional aspect, at block 802, the recording at block 702 of the audio stream further comprises recording for a time duration that is equal to or greater than a period of successive emissions of the one or more audio detection test tones.

For example, in various aspects a time duration of one audio detection test tone may be two seconds. Accordingly, the recording at block 802 may be longer than two seconds, in order to determine that the entire tone has been recorded. Alternatively, more than one audio detection test tone may be emitted over a period of time. For example, a series of five audio detection test tones may be emitted over a time period spanning twenty seconds. Accordingly, the recording at block 802 may be longer than twenty seconds, in order to determine that the entire series of audio detection test tones has been emitted. This recording for a time duration that is equal to or greater than a period of successive emissions of the one or more audio detection tones can be performed so that an interruption in the series of tones can be detected and/or so that an entire tone or series of tones can be detected.

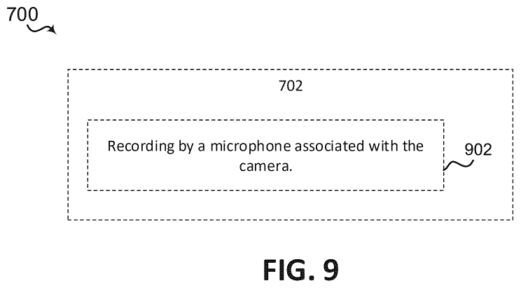

Referring to FIG. 9, in an alternative or additional aspect, at block 902, the recording at block 702 of the audio stream further comprises recording by a microphone associated with the camera.

For example, a recording component (e.g., one or more microphones 104) that is associated with a camera (e.g., camera 102) can record an audio stream that may include one or more audio detection test tones emitted by an emitting component 635 (e.g., a speaker 106). This can provide for an audio detection blackout system to capture data (e.g., an audio stream) in which one or more audio detection test tones are emitted, so that a determining component (e.g., determining component 125) can determine if an the one or more audio detection test tones are present in the captured data and/or if an audio blackout has, is, or may be occurring. Accordingly, the recording component 620 can begin recording at a recording time before or at the time that one or more audio detection test tones are emitted. This recording time that by coordinated and/or otherwise synchronized via audio blackout detection component 615 according to a clock in various aspects. This ensures that the audio blackout detection component is able to accurately assess whether an audio blackout has, is, or may be occurring. In some aspects an indicator can be used to indicate that recording component 620 successfully began recording. Alternatively, no indicator may be used and the presence of recorded data can be self-evident that a recording has occurred. In some aspects a determining component 125 may be able to determine if one or more parts of recorded data such as an audio stream are void of data even in the absence of one or more audio detection test tones, thereby indicating that an anomaly or other issue has occurred with respect to recording component 620.

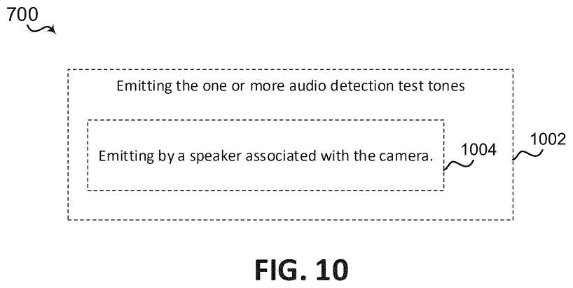

Referring to FIG. 10, in an alternative or additional aspect, at block 1002, the method 700 may further include emitting the one or more audio detection test tones. For example, in an aspect, computing device 100, one or more processors 105, one or more memories 109, audio blackout detection component 615, and/or emitting component 635 may be configured to or may comprise means for emitting the one or more audio detection test tones.

For example, the emitting at block 1002 may include an emitting component 635 to emit the one or more audio detection test tones. In various aspects, emitting component 635 can be a speaker 106 that is associated with a camera 102, neighbor camera 108, and/or is a standalone speaker. The emission of each of or a set of the one or more audio detection test tones can be associated with a particular time that is coordinated by a central clock or timer in various aspects. This allows for a determining component 125 of an audio blackout detection system to know where or when in a data stream such as an audio stream that the one or more audio detection test tones are expected to be located and/or occur. In various aspects the emitting component 635 can be configured to emit one or more audio detection test tones that comprise one or more frequencies that are audible and/or inaudible. This allows for the determining component 125 to know what type of audio detection test tones to search for in the recorded data stream (e.g., audio stream).

Further, for example, the emitting at block 1002 may be performed and the knowledge of when or where in the recorded data stream and/or what frequency/frequencies are emitted provides for accurate determining by the determining component 125 of the occurrence of an audio blackout.

In this optional aspect, at block 1004, the emitting at block 1002 of the one or more audio detection test tones further comprises emitting by a speaker associated with the camera.

For example, this emitting by a speaker associated with the camera provides for a location of an audio blackout to be determined, because the location of the camera is known to the audio blackout detection system and/or users of the audio blackout detection system. Accordingly, for example in a security system with a quantity of cameras exceeding one camera, the audio blackout detection system can determine which of the cameras may be subject to an audio blackout.

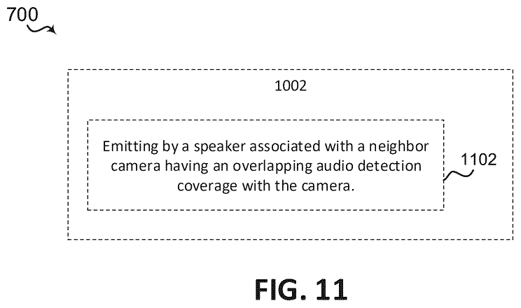

Referring to FIG. 11, in an alternative or additional aspect, at block 1102, the emitting at block 1002 of the one or more audio detection test tones further comprises emitting by a speaker associated with a neighbor camera having an overlapping audio detection coverage with the camera.

For example, in aspects where more than one cameras are used in a security system, a speaker associated with a neighbor camera can emit one or more audio detection test tones a camera can record the emitted audio detection test tone(s) when the camera and neighbor camera have overlapping coverage. This provides for enhanced audio blackout detection, whereby the components of the cameras provide a security network or mesh and audio blackout of one camera may be effectively detected by another camera. In the event that audio blackout detection occurs with respect to one or more cameras, other neighboring cameras can be used to narrow down a zone of the audio blackout and/or provide backup coverage.

Referring to FIG. 12, in an alternative or additional aspect, at block 1202, the method 700 may further include transmitting at least one of the one or more notifications to another device. For example, in an aspect, computing device 100, one or more processors 105, one or more memories 109, audio blackout detection component 615, and/or transmitting component 640 may be configured to or may comprise means for transmitting at least one of the one or more notifications to another device.

For example, the transmitting at block 1202 may include a camera transmitting the notification to one or more devices at a central control center (e.g., command center 150) and/or user devices associated with appropriate users (e.g., security personnel). Alternatively, or additionally, if computing device 100 is a server or other computer, computing device 100 can transmit the notification to a central control center (e.g., command center 150) and/or user devices associated with appropriate users (e.g., security personnel). Alternatively, or additionally, if computing device 100 is a computer associated with a webcam that is being used for audio blackout detection, transmitting the one or more notifications to another device can include transmitting the one or more notifications to a user device of an appropriate user (e.g., a supervisor, manager, boss, or other appropriate user).

Further, for example, the transmitting at block 1202 may be performed so that the notification reaches another device that is used by a user who can review and/or remedy an issue cause by an audio blackout. For example, the user can investigate whether an audio blackout is occurring and address the issue by locating a device that is causing the audio blackout, confronting or disabling a person or device causing the audio blackout, and/or reprimanding the person causing the audio blackout.

Referring to FIG. 13, in an alternative or additional aspect, at block 1302, the method 700 may further include recording a subsequent audio stream if the one or more audio detection test tones are present in the audio stream. For example, in an aspect, computing device 100, one or more processors 105, one or more memories 109, audio blackout detection component 615, and/or recording component 620 may be configured to or may comprise means for recording a subsequent audio stream if the one or more audio detection test tones are present in the audio stream.

For example, the recording at block 1302 may include recording a subsequent audio stream using a recording component 620 if the one or more audio detection test tones are determined to be present in the audio stream by determining component 125.

Further, for example, the recording at block 1302 may be performed so that an audio blackout that occurs subsequent to a non-audio blackout can be determined. This allows for an audio blackout detection system to provide continuing audio blackout detection operations even in the event that one or more audio detection test tones are present in an audio stream.

In this optional aspect, at block 1304, the method 700 may further include determining if the one or more audio detection test tones are present in the subsequent audio stream. For example, in an aspect, computing device 100, one or more processors 105, one or more memories 109, audio blackout detection component 615, and/or determining component 125 may be configured to or may comprise means for determining if the one or more audio detection test tones are present in the subsequent audio stream.

For example, the determining at block 1304 may include determining component 125 determining if the one or more audio detection test tones are present in the subsequent stream recorded by recording component 620.

Further, for example, the determining at block 1304 may be performed so that an audio blackout that occurs subsequent to a non-audio blackout can be determined. This allows for an audio blackout detection system to provide continuing audio blackout detection operations even in the event that one or more audio detection test tones are present in an audio stream.

In this optional aspect, at block 1306, the method 700 may further include generating the one or more notifications if the one or more audio detection test tones are not present in the subsequent audio stream. For example, in an aspect, computing device 100, one or more processors 105, one or more memories 109, audio blackout detection component 615, and/or generating component 130 may be configured to or may comprise means for generating the one or more notifications if the one or more audio detection test tones are not present in the subsequent audio stream.

For example, the generating at block 1306 may include a generating component 130 generating one or more notifications, alerts and/or alarms if the one or more audio detection tones are not present in the subsequent audio stream.

Further, for example, the generating at block 1306 may be performed so that an audio blackout that occurs subsequent to a non-audio blackout can trigger an alert, alarm, or notification that can be reviewed and/or addressed by appropriate personnel. This allows for an audio blackout detection system to provide continuing audio blackout detection operations even in the event that one or more audio detection test tones are present in an audio stream.

Some further example aspects of the devices described herein are provided in the following clauses.
1. A method of audio blackout detection in a security system, comprising:
recording an audio stream associated with a camera in the security system;
determining if one or more audio detection test tones are present in the audio stream, wherein at least one of the one or more audio detection test tones is inaudible to a human; and
generating one or more notifications if the one or more audio detection test tones are not present in the audio stream.
2. The method of clause 1, wherein the one or more audio detection test tones comprise a plurality of tones.
3. The method of clause 2, wherein the plurality of tones is unique to the camera.
4. The method of any of the above clauses, wherein recording the audio stream further comprises recording for a time duration that is equal to or greater than a period of successive emissions of the one or more audio detection test tones.
5. The method of any one of the above clauses, wherein recording the audio stream further comprises recording by a microphone associated with the camera.
6. The method of any of the above clauses, further comprising: emitting the one or more audio detection test tones.
7. The method of clause 6, further comprising: wherein emitting the one or more audio detection test tones further comprises emitting by a speaker associated with the camera
transmitting at least one of the one or more notifications to a user device.
8. The method of clause 6 or 7, wherein emitting the one or more audio detection test tones further comprises emitting by a speaker associated with a neighbor camera having an overlapping audio detection coverage with the camera.
9. The method of any of the above clauses, further comprising: transmitting at least one of the one or more notifications to a user device.
10. The method of any of the above clauses, recording a subsequent audio stream if the one or more audio detection test tones are present in the audio stream;
determining if the one or more audio detection test tones are present in the subsequent audio stream; and
generating the one or more notifications if the one or more audio detection test tones are not present in the subsequent audio stream.
11. An apparatus for audio blackout detection in a security system, comprising:
one or more memories; and
one or more processors coupled with one or more memories and configured, individually or in combination, to:
record an audio stream associated with a camera in the security system;
determine if one or more audio detection test tones are present in the audio stream, wherein at least one of the one or more audio detection test tones is inaudible to a human; and
generate one or more notifications if the one or more audio detection test tones are not present in the audio stream.
12. The apparatus of clause 11, wherein the one or more audio detection test tones comprise a plurality of tones.
13. The apparatus of clause 12, wherein the plurality of tones is unique to the camera.
14. The apparatus of an of clauses 11-13, wherein to record the audio stream the one or more processors are further configured to record for a time duration that is equal to or greater than a period of successive emissions of the one or more audio detection test tones.
15. The apparatus of any of clauses 11-14, wherein to record the audio stream the one or more processors are further configured to record by a microphone associated with the camera.
16. The apparatus of any of clauses 11-15, wherein the one or more processors are further configured to:
emit the one or more audio detection test tones.
17. The apparatus of any of clauses 11-16, wherein emitting the one or more audio detection test tones the one or more processors are further configured to emit by a speaker associated with the camera.
18. The apparatus of any of clauses 11-17, wherein emitting the one or more audio detection test tones the one or more processors are further configured to emit by a speaker associated with a neighbor camera having an overlapping audio detection coverage with the camera.
19. The apparatus of any of clauses 11-18, wherein the one or more processors are further configured to:
transmit at least one of the one or more notifications to another device.
20. The apparatus of any of clauses 11-19, wherein the one or more processors are further configured to:
record a subsequent audio stream if the one or more audio detection test tones are present in the audio stream;
determine if the one or more audio detection test tones are present in the subsequent audio stream; and
generate the one or more notifications if the one or more audio detection test tones are not present in the subsequent audio stream.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method of audio blackout detection in a security system, comprising:
recording an audio stream associated with a camera in the security system;
determining if one or more audio detection test tones are present in the audio stream, wherein at least one of the one or more audio detection test tones is inaudible to a human; and
generating one or more notifications if the one or more audio detection test tones are not present in the audio stream.

2. The method of claim 1, wherein the one or more audio detection test tones comprise a plurality of tones.

3. The method of claim 2, wherein the plurality of tones is unique to the camera.

4. The method of claim 1, wherein recording the audio stream further comprises recording for a time duration that is equal to or greater than a period of successive emissions of the one or more audio detection test tones.

5. The method of claim 1, wherein recording the audio stream further comprises recording by a microphone associated with the camera.

6. The method of claim 1, further comprising:
emitting the one or more audio detection test tones.

7. The method of claim 6, wherein emitting the one or more audio detection test tones further comprises emitting by a speaker associated with the camera.

8. The method of claim 6, wherein emitting the one or more audio detection test tones further comprises emitting by a speaker associated with a neighbor camera having an overlapping audio detection coverage with the camera.

9. The method of claim 1, further comprising:
transmitting at least one of the one or more notifications to a user device.

10. The method of claim 1, further comprising:
recording a subsequent audio stream if the one or more audio detection test tones are present in the audio stream;
determining if the one or more audio detection test tones are present in the subsequent audio stream; and
generating the one or more notifications if the one or more audio detection test tones are not present in the subsequent audio stream.

11. An apparatus for audio blackout detection in a security system, comprising:
one or more memories; and
one or more processors coupled with one or more memories and configured, individually or in combination, to:
record an audio stream associated with a camera in the security system;
determine if one or more audio detection test tones are present in the audio stream, wherein at least one of the one or more audio detection test tones is inaudible to a human; and
generate one or more notifications if the one or more audio detection test tones are not present in the audio stream.

12. The apparatus of claim 11, wherein the one or more audio detection test tones comprise a plurality of tones.

13. The apparatus of claim 12, wherein the plurality of tones is unique to the camera.

14. The apparatus of claim 11, wherein to record the audio stream the one or more processors are further configured to record for a time duration that is equal to or greater than a period of successive emissions of the one or more audio detection test tones.

15. The apparatus of claim 11, wherein to record the audio stream the one or more processors are further configured to record by a microphone associated with the camera.

16. The apparatus of claim 11, wherein the one or more processors are further configured to:
emit the one or more audio detection test tones.

17. The apparatus of claim 16, wherein emitting the one or more audio detection test tones the one or more processors are further configured to emit by a speaker associated with the camera.

18. The apparatus of claim 16, wherein emitting the one or more audio detection test tones the one or more processors are further configured to emit by a speaker associated with a neighbor camera having an overlapping audio detection coverage with the camera.

19. The apparatus of claim 11, wherein the one or more processors are further configured to:
transmit at least one of the one or more notifications to another device.

20. The apparatus of claim 11, wherein the one or more processors are further configured to:
record a subsequent audio stream if the one or more audio detection test tones are present in the audio stream;
determine if the one or more audio detection test tones are present in the subsequent audio stream; and
generate the one or more notifications if the one or more audio detection test tones are not present in the subsequent audio stream.
